(19) United States
(12) Patent Application Publication
(10) Pub. No.: US 2012/0066035 A1
(43) Pub. Date: Mar. 15, 2012

(54) RF FINGERPRINTS FOR CONTENT LOCATION

(75) Inventors: Philip Stanger, Victoria B.C. (CA); Steven Gillan, Victoria B.C. (CA)

(73) Assignee: WiFarer Inc.

(21) Appl. No.: 13/230,426

(22) Filed: Sep. 12, 2011

Related U.S. Application Data
(60) Provisional application No. 61/381,903, filed on Sep. 10, 2010.
(60) Provisional application No. 61/493,901, filed on Jun. 6, 2011.

(51) Int. Cl. H04W 4/02; G06F 17/30

(52) U.S. Cl. 705/14.1; 455/456.2; 705/14.57; 707/802; 707/E17.044

(57) ABSTRACT

Content Management Systems (CMSs) can be configured to edit available content. The CMS can be provided as a web interface so that content can be rapidly updated. User data can be collected associated with an individual user or one or more specific locations. Examples include information related to venue traffic, efficacy of floor plan and layout, store placement, advertising rates as a function of location, lease rates, user demographics, user purchasing habits, and other user profiles.

### CROSS REFERENCE TO RELATED APPLICATIONS

This application claims the benefit of U.S. Provisional Application 61/381,903, filed Sep. 10, 2010, and U.S. Provisional Application 61/493,901, filed Jun. 6, 2011, both of which are incorporated herein by reference.

### BACKGROUND

Mobile device use has become widespread. Many users depend on these devices to look up information on the Internet, check the weather, read news, and navigate to new destinations. However, the content users receive is generally limited in view of the relatively imprecise location information available at the mobile device. In addition, much of the information provided to users is only generally related to user location, and determining details of a user's local environment can be impossible.

Merchants have adopted a variety of ways of communicating with much potential customers using mobile devices. For example, users can receive emails that may or may not include a vendor coupon, or a vendor can pay for placement on a web page or a map returned from a web page. These ways are generally neither timely, well targeted, nor closely associated with current user location. Improved methods and apparatus for providing timely, location based information tailored to a particular user are needed.

### SUMMARY

The disclosure pertains to methods and apparatus for generating RF signatures that are associated with particular locations, and assigning and delivering content based on such signatures. Details are presented below with reference to the accompanying drawings.

Disclosed are navigation systems and methods that can guide a user to a destination using a smartphone to show route and current location, and provide route-based content. Unlike conventional GPS or RFID systems, no special hardware is required and operation range can be very larger. A single downloadable application can be configured to retrieve, display, and forward content associated with a variety of content providers. Content providers can forward mobile device display backgrounds, screen savers, text, audio, video to provide information about available products and services. Venue-specific application modules can be provided for airports (for example, flight information), museums (for example, museum tours), and in-seat sales at stadium, and other purposes. The application can provide an input configured to present content that is likely associated with providers that are within view of the mobile device user. Location based searching can be provided, and coupons or other customer enticements can be delivered. Navigational information for travel from a current location to a target can be provided.

A Content Management System (CMS) can be configured to edit available content. The CMS can be provided as a web interface so that content can be rapidly updated. User data can be collected associated with an individual user and one or more specific locations. Examples include information related to venue traffic, efficacy of floor plan and layout, store placement, advertising rates as a function of location, lease rates, user demographics, and user purchasing habits. In some examples, methods for identifying local points of interest within an indoor environment are provided in which points of interest are identified dynamically as pop-up icons on a map displayed on user's mobile device or other types of notifications as a user comes near to them, but there are numerous other examples and applications.

In some examples, content delivery systems comprise a network interface configured to receive requests for content associated with a selected map location, the request including a radio frequency (RF) signature associated with the location. A processor is configured to identify at least one content element associated with the RF signature. In some examples, the RF signature is associated with a wireless access point identifier and at least one received signal strength associated with the wireless access point. In further examples, the processor is configured to retrieve at least one content element and communicate the content element via the network interface, and the content element is an audio file, a video file, a store coupon, or a text file. In some examples, the processor is configured to provide an indication of the availability of content associated with map locations proximate the selected map location.

Systems comprise at least one computer readable medium configured to store RF signatures in association with corresponding map locations and content. A user interface is configured to receive selections of map locations and assign content to at least one of the map locations. In some embodiment, the user interface is configured to assign at least one content notice type to a content item, wherein the content notice type is associated with display of the content item based on presence at the associated location. In other examples, the system provides a map display so as to display a map location for the assignment of content.

Methods comprise providing vendor specific content associated with a location based on a radio frequency signature and receiving at least one indication of user access to the vendor specific content. A value of the user access is estimated based on the at least one indication. In some examples, the value is based on a number of user accesses to the content or a number of user accesses to vendor premises associated with content, and a vendor is charged based on the value.

Methods comprise obtaining radio frequency (RF) signatures for a plurality of venue locations and assigning content to at least one venue location. Content is provided in response to receipt of an RF signature associated with at least one location. In some examples, the RF signatures include a location identifier and at least one characteristic of the radio frequency emissions associated with the location or a Service Set Identifier associated with a wireless access point proximate the location. In some examples, the at least one content item is denoted as a pop-up item.

These and other features and aspects of the disclosed technology are set forth below with reference to the accompanying drawings.

### BRIEF DESCRIPTION OF THE DRAWINGS

FIG. 1A is a block diagram illustrating a representative method for assigning radio frequency signatures to physical locations based on a scan of RF signals associated with WiFi access points, routers, and other WiFi connections.

FIG. 1B is a block diagram illustrating a representative method of determining a location of a mobile devise based on RF signatures.

FIG. 2 illustrates a user interface for associating content with locations.

FIGS. 3-5 illustrate mobile device displays provided for selection or display of location based content.

FIG. 6 illustrates a representative computer environment for implementation of the disclosed methods.

FIG. 7 is a representative mobile device display associated with providing content for a plurality of locations and displaying the availability of content to a user of the mobile device.

FIG. 8 is a block diagram of a representative method of detecting a change of location such as a change of floors in a multi-story venue and updating a mobile device display with a corresponding floor map and associated content.

FIG. 9 is a block diagram of a representative method of dynamic content display that includes providing a displayed marker pin at one or more locations at which venue content is available, and responding to user input such as user contact with touch screen locations at or near one or more displayed marker pins by providing location based content on the display at or near the marker pin or in a banner area. As shown in FIG. 15, the banner area is situated at a bottom edge of the mobile device display.

FIGS. 10A-10B illustrate a block diagram of a representative method of providing user route directions such as displaying a route map and retrieving/displaying available content or the availability of content around a user location.

FIG. 11 is a block diagram of representative method of providing venue specific applications to a mobile device.

FIG. 12 is a block diagram of a representative method of determining the availability of content associated with location of a user mobile device, and indicating the availability of such content on a display such as a map display on a mobile device. A representative display provided in this manner is shown in FIG. 7.

FIG, 13 is a block diagram illustrating a representative system for providing venue specific content that include a venue manager, a location based service provider, and a navigation or wayfinding engine.

FIG. 14 illustrates a mobile device configured to execute a venue specific application program and provide a venue specific or brandable display image.

FIG. 15 illustrates a mobile device configured to provide dynamic category-based searching to provide search results associated with mobile device location or a user definable region around a mobile device location. The mobile device can also be configured to provide a location-based display field for content such as a targeted advertisement.

FIG. 16 illustrates a mobile device configured to display location based content such as content associated with a museum collection.

FIG. 17 illustrates a user interface display for adding content for association with a location.

FIGS. 18A-18B is a block diagram of a representative method of saving venue specific content at a mobile device such as a handset.

FIG. 18C is a block diagram of a representative method of sending venue specific content.

FIG. 19 is a block diagram illustrating methods for interacting with digital signage and showing communications between a handset, a server, and a digital sign.

FIGS. 20A-20B illustrate message updates associated with interactions with digital signage. FIG. 20A shows addition of a new message to a top of a list of messages displayed on a handset. FIG. 20B shows removal of a message (Message 2) from a list in response to, for example, the user no longer being present at a location associated with the message.

FIG. 21 illustrates a method of serving retailer content to mobile device users and charging retailers based on content access by the users.

FIG. 22 illustrated display of a vendor coupon at an associated map location on a mobile device display.

FIG. 23 illustrates a mobile device application that is based on stored computer-executable instructions for retrieving such content, depending on availability of content in a particular venue.

FIG. 24 illustrates a method of operating a venue administration website which is configured to associate data such as audio or video data, graphics or text with specific locations and provide such data to a content database for retrieval by a mobile device.

FIG. 25 illustrates a method of access point name re-assignment.

### DETAILED DESCRIPTION

As used in this application and in the claims, the singular forms “a,” “an,” and “the” include the plural forms unless the context clearly dictates otherwise. Additionally, the term “includes” means “comprises.” Further, the term “coupled” does not exclude the presence of intermediate elements between the coupled items.

The systems, apparatus, and methods described herein should not be construed as limiting in any way. Instead, the present disclosure is directed toward all novel and non-obvious features and aspects of the various disclosed embodiments, alone and in various combinations and sub-combinations with one another. The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art.

For convenience, user actions are referred to in some of the following examples. Such actions typically refer to execution of computer-executable instructions by a computing device such as a computer, mobile phone, or other device. In some cases, “user” may be understood to refer to “user device.” It will be apparent that in many examples, user devices are responsive to user inputs at, for example, a touch screen or other input device.

Content associated with a particular location can be provided to a user of mobile communication device if the current location of the device is available. Surprisingly accurate and reliable location data can be established based on radiofrequency (RF) signatures that are developed based on local RF signals associated with wireless communications based on IEEE 802.11 standards or other wireless networking standards or configurations. As used herein, RF refers to electromagnetic signals of frequencies between 1 MHz and 100 GHz. By surveying local RF signals, and generating an RF signature based on the detected RF signals, RF signatures can be associated with spatial locations. Signals from one or more wireless access points can be detected at a plurality of locations so as to develop an RF signature map.

Although signatures are conveniently based on IEEE 802.11 protocols due to their widespread implementation, other RF signal-based protocols such those described in IEEE 802.15 such as so-called BLUETOOTH protocols and ZIGBEE protocols can be used. In some applications, these alternative standards are preferred. For example, ZIGBEE-based devices can be battery powered and thus continue to operate in situations in which power fails as may be expected in emergencies such as fires or accidents. Therefore, security and rescue personnel can determine locations based on these signatures and respond accordingly.

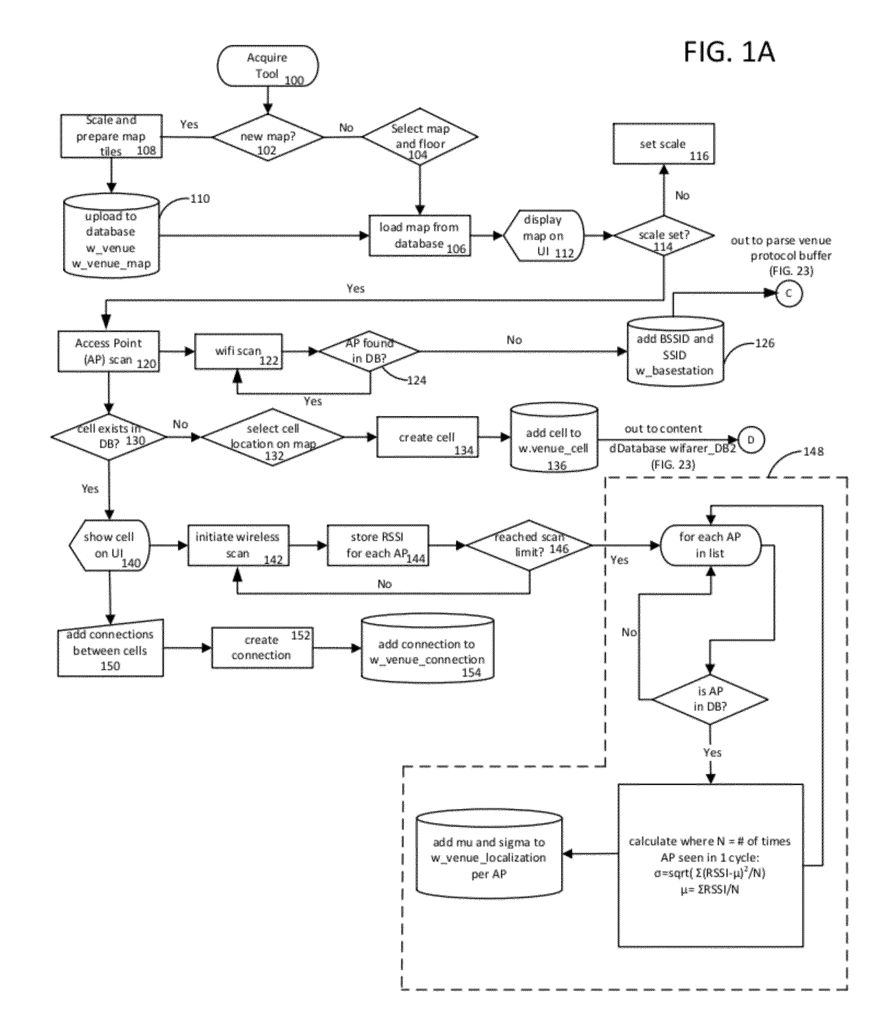

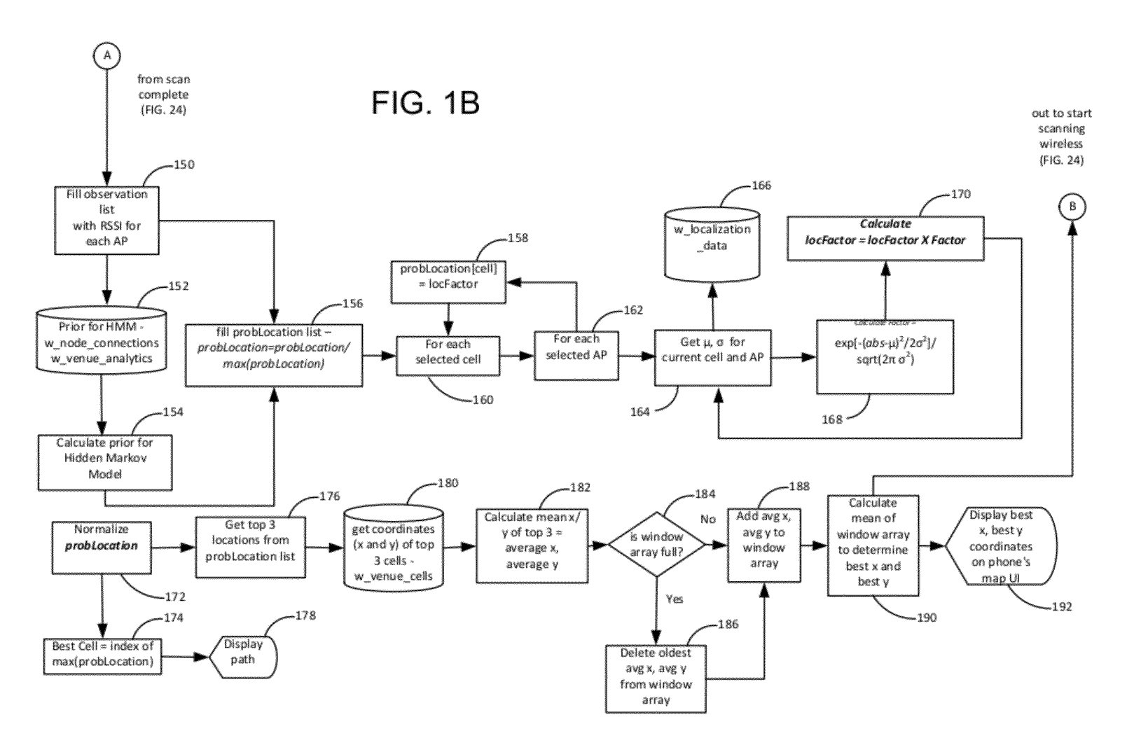

A representative method of generating and mapping RF signatures is illustrated in FIG. 1A. Typically, RF signatures are based on one or more functions of a received signal strength indicator (RSSI) which is based on detected power produced on one or more RF frequency channels by wireless networking devices such as access points (AP) and routers. Available local devices can be interrogated, and identifications can be added to a database. For example, a Service Set identifier (SSID) identifying a particular AP can be stored, or a Basic Service Set Identifier (BSSID) can be stored. A BSSID typically is a unique identifier, and in some cases is the MAC address of an AP. By surveying an area, an RF signature map can be established.

With reference to FIG. 1A, a method of assigning radio frequency (RF) signatures to one or more physical locations includes initialization of an acquisition procedure by, for example, supplying a map of locations for which signatures are to be determined at 100. If the map is available from a previous assignment procedure is available as determined at 102, the map is selected at 104. In some applications, the selection of the map also includes selection of a floor for which signature acquisition is desired. At 106, map data such as map tiles, cells, or associated RF signatures for locations associated with the map are retrieved from venue database. If a new map is to be scanned, the map is scanned and divided into map tiles at 108, and the scaled map and tiles are stored in the venue database at 110. At 106, map data for the new map can be retrieved from the venue database.

Map data can be displayed on a user interface at 112, typically on a display screen of a mobile device such as a smart phone, a netbook computer, or laptop computer, but other devices can be used. In order to show estimated time and distance to selected targets during navigation, at 114 a request for a previously determined scale is provided to a venue database or based on a prior scan. If no scale has been set previously or is unavailable, a suitable scale is set at 116 and the scale can be stored for later use.

Access point scanning begins at 120, typically by initiating scanning for wireless networks (“Wi-Fi scanning”) at 122. Received wireless signals are processed at 124, and if a wireless network access point that is already associated with the selected map is detected at 124, scanning continues at 122. If a wireless network is detected that is not found in an access point database associated with the selected map, identifiers associated with the detected access point are added to an access point database at 126. Typically wireless access point parameter such as base station service set identification (BSSID) or a service set identifier (SSID) is stored. For such access points, associated content can be obtained in a venue parsing procedure illustrated in FIG. 1C and discussed below.

If no cells are determined to be associated with an access point at 130 (i.e., an access point database does not include cell divisions), a cell location is selected on the map at 132 and a cell is created at 134. Cell geometry can be created based on defaults position ranges, or based on total area, perimeter, or volume to be associated with a cell. Alternatively, cell geometry can be individually set for any set of cells, one cell, or all cells by, for example, user selection of cell geometry on a graphical user interface or otherwise selected. At 136, cell data is added to a venue database. If a previously established cell is identified at 130, the cell is displayed on a user interface at 140. A wireless scan of each access point associated with the cell is initiated at 142, and a received signal strength indication (RSSI) for each access point is stored at 144. A number of scans for measurement of RSSI can be set, and at 146 it is determined if the scan limit has been reached. If not, scanning continues at 142. If the scan limit has been reached, scan results can be stored at 148. For some (typically all) scanned access points, a standard deviation of scanned RSSI values and a mean RSSI value are determined, and the standard deviation and mean are store in a venue database. A 150, connections to other cells are added, and at 152, connections are created. Connections are added to a venue database at 154. With reference to FIG. 1A, typically, an RSSI or similar identifier associated with access point is identified at 150 and stored in a database 152

As shown in FIG. 1B, a mobile device can be configured to interrogate local RF signals and determine the local RF signature. The mobile device detects local RF signals, and processes these RF signals to produce a local signature and/or an estimate of mobile device location. Alternatively, local signal levels and other parameters such as SSIDs, BSSIDs, or RSSIs can be supplied to a remote, network based system that can return location information to the mobile device. Alternatively, the location of the mobile device need not be directly available to the mobile device, but instead provided to and used by a content provider in identifying suitable, location-specific content.

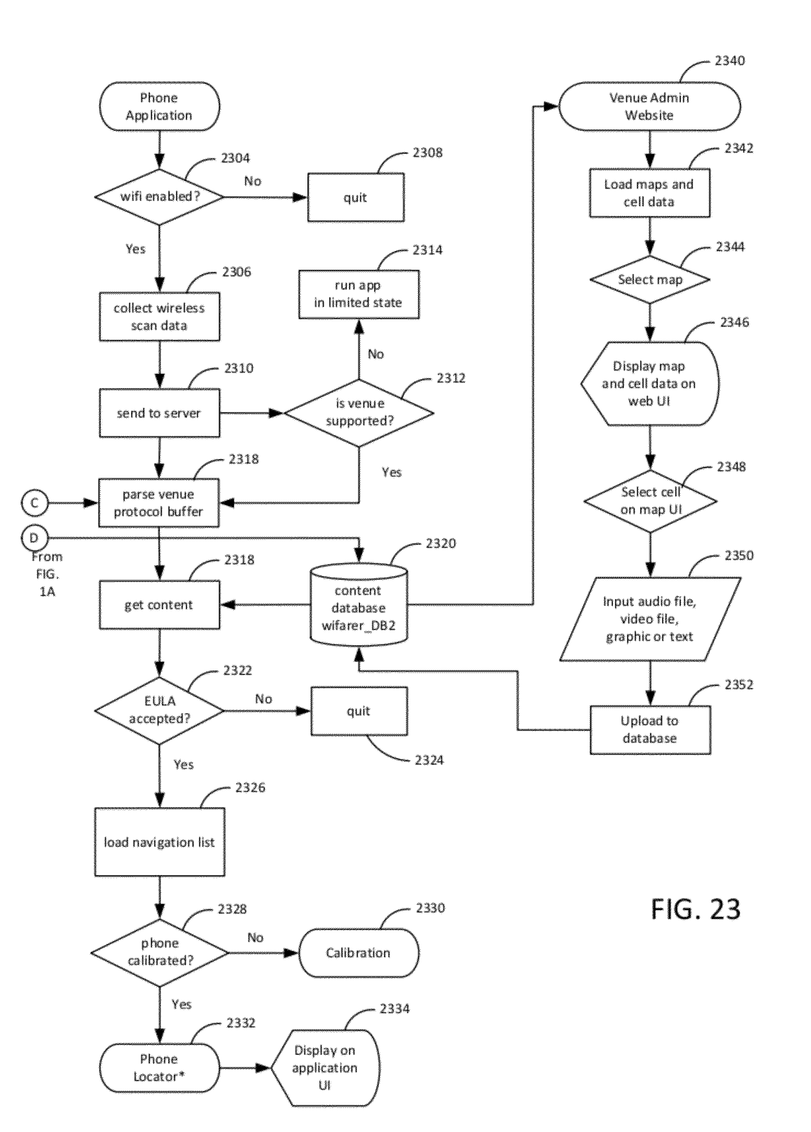

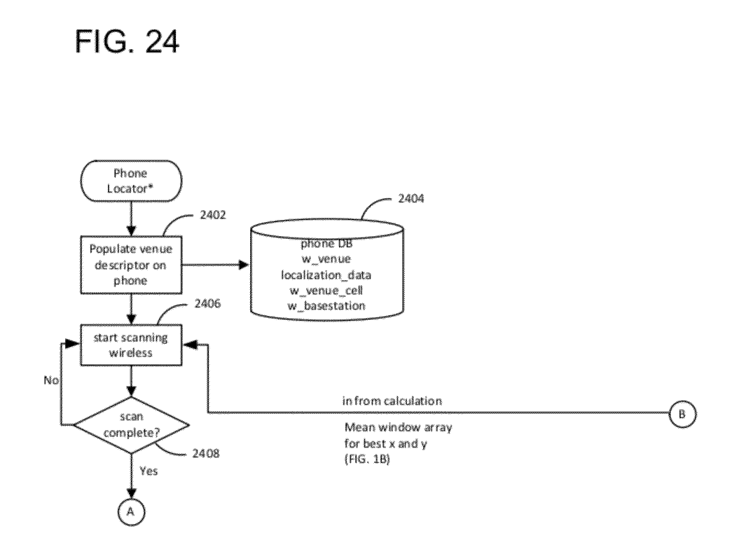

FIG. 23 illustrates a mobile device application that is based on stored computer-executable instructions for retrieving such content, depending on availability of content in a particular venue and FIG. 24 illustrates a method of operating a venue administration website which is configured to associate data such as audio or video data, graphics or text with specific locations and provide such data to a content database for retrieval by a mobile device.

Referring to FIG. 23, operation of a representative content application at a mobile device includes checking wireless network status (typically WIFI status) of the mobile device at 2304, and if WIFI is not active, the application quits at 2308. Otherwise, at 2306 wireless scan data is collected and sent to a content or location server at 2310. Based on the scan data, the availability of venue content is indicated as being fully or partially available (or unavailable) at 2312. If the venue is partially supported or unsupported, the mobile application executes in a limited state at 2314, or if fully supported a venue specific activities and data are retrieve by parsing a venue protocol buffer at 2318.

Venue content can be returned at 2318 and stored in a content database 2320. Generally after the application is initiated for the first time, a user is requested to accept an End User License Agreement (EULA) at 2322 and if not accepted, the application quits at 2324. Otherwise, a navigation list is loaded at 2326. Mobile device calibration can be selected at 2328 and the calibration is carried out at 2330. The location of the mobile device is then estimated at 2328 and displayed at 2334 along with location specific content and user interface and other elements of the mobile application.

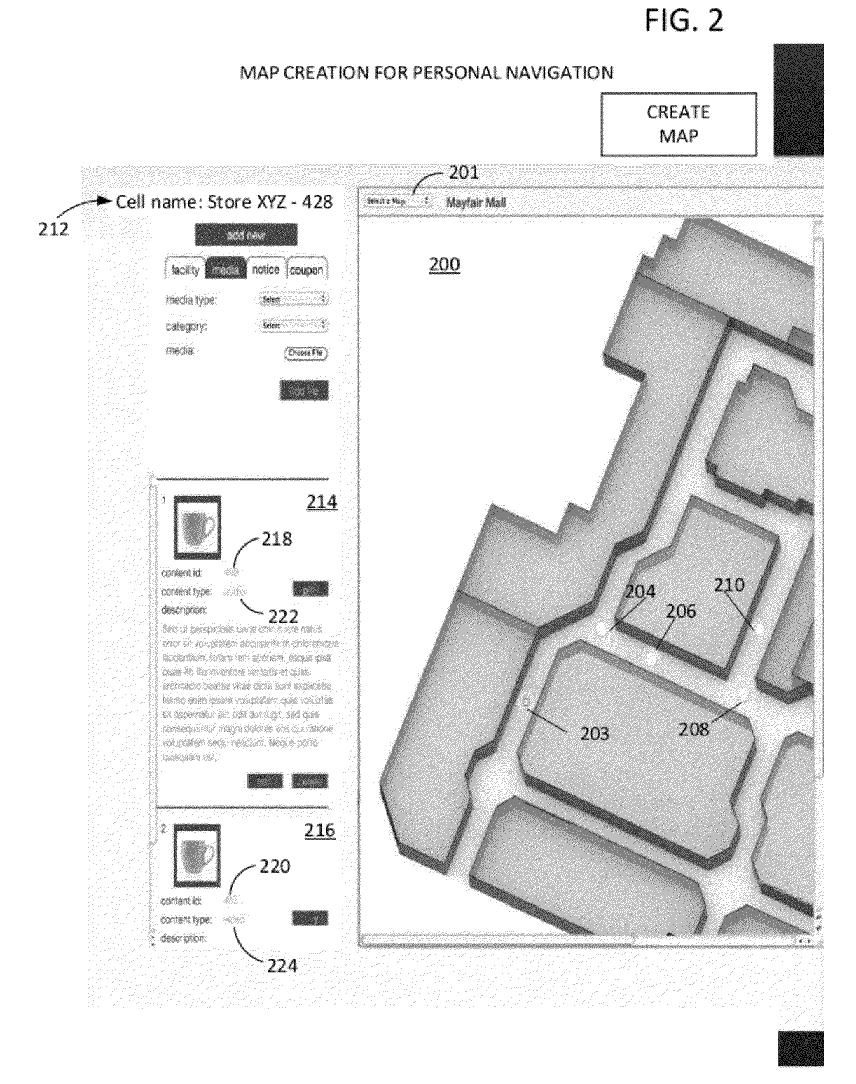

Referring to FIG. 23, venue administration 2340 is based on website that can be used to provision the content database 2320. (As noted above, a representative user interface for venue administration is illustrated in FIG. 2.) Maps and cell data are loaded at 2342. A map is selected at 2344 and displayed at 2346, typically on a web-enabled user interface. One or more cells are selected at 2348 using the displayed map, and content is added at 2350. At 2352, content is uploaded to the database 2320 for access by mobile devices.

FIG. 2 is a representation of visual user interface 200 configured to display a map of a venue or portion thereof (such as a shopping mall or selected area in a shopping mall) in which RF signature location information can be associated with content to be provided at one or more cells. An input field 201 such as a list of available maps is provided for selection of a particular map. For example, the list can include available maps associated with a plurality of venues, or available maps or portions of map that are available for a particular venue. As shown in FIG. 2, a location or cell 203 is selected for content association, and a marker associated with the location is displayed with a selected color, shape, or emphasis such as highlighting or blinking, or other indication that content provided will be associated with the cell 203. Locations 204, 206, 208, 210 are indicated as suitable for content association in view of the availability of an RF signature for these locations and/or requests to associate customer supplied content with these locations. Available locations can be displayed using selected colors, shapes, or other display characteristics, but are generally displayed differently than a marker associated with an active cell for which content can be currently assigned.

The visual interface is configured to permit a cell name or descriptor to be presented in a cell name area 212, in conjunction with entry of cell content data based on description of the cell such as goods, services, or businesses located at or near the cell, media, notices, or shopping coupons associated with the selected cell. As shown in FIG. 2, various types of content can be provided such as information about a local facility (for example, a store), media (music or videos) associated with the facility, available shopping coupons, or other content. Typically the available content is suitable for nearby businesses, and a potential customer alerted to such content based on an RF signature. In the example of FIG. 2, content items 214, 216 associated with the cell 208 are displayed with content reference identifiers 218, 220 and content type identifiers 222, 224 along with corresponding content descriptions. Content is generally added by adding a corresponding data file or a link to selected content.

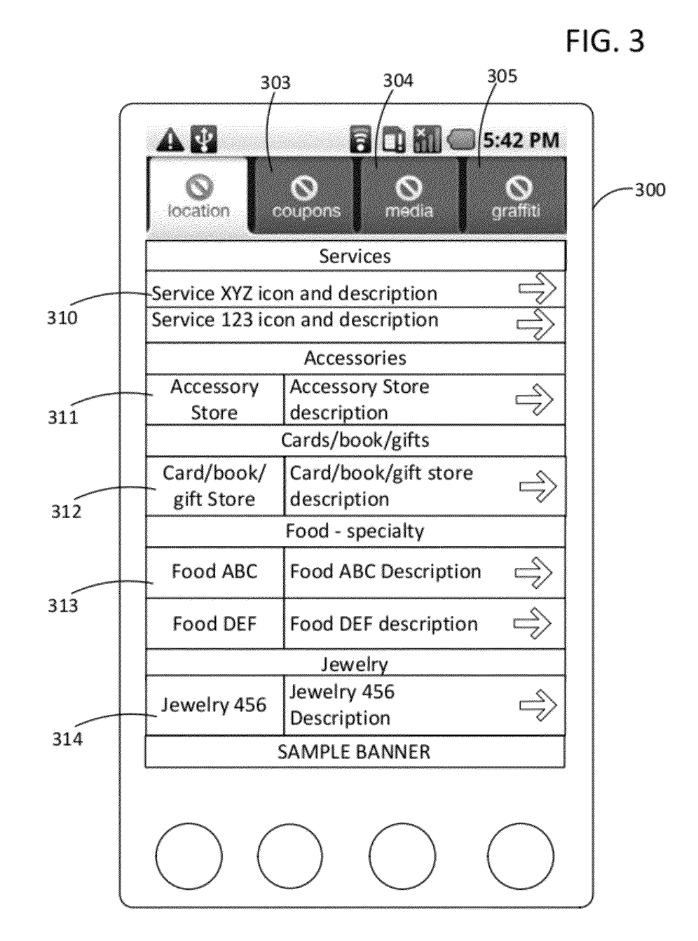

FIG. 3 illustrates a representative mobile device 300 that includes a display configured to display a directory of available vendors or services associated with a selected venue. The mobile device display is configured to provide user selectable input fields 303-305 for selection of content associated with available vendors, coupons, media, or user comments associated with a current location (or a currently selected vendor), respectively. In the example of FIG. 3, vendors and services are presented in categories in respective display areas 310-314. Typically, each of these displays areas is user expandable or contractible based on user input such as touchscreen input. In addition, in each of the areas 310-314, user selection of a particular item can be configured to activate presentation of a full display of content associated with the particular item, or expand the display area available for the selected item. In a representative application, a user in a shopping mall can access content that is associated with vendors within a predetermined area about the user based on mobile device interrogation of available wireless access points to obtain SSIDs and RSSs. Venue content can also be provided for more distant locations as well. In addition, content such as shopping coupons associated with vendors at or near a user location can be provided.

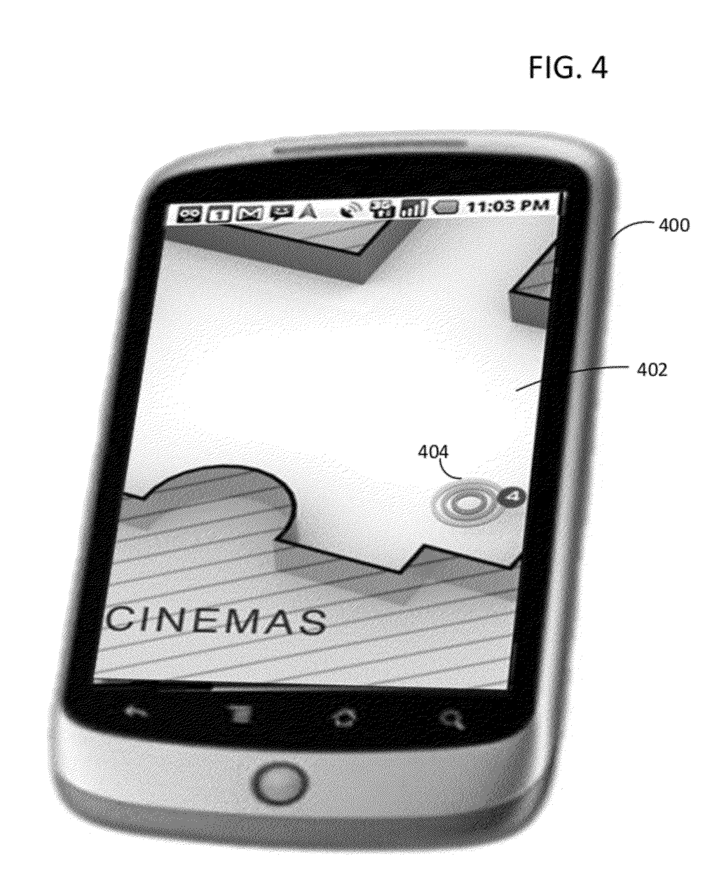

FIG. 4 illustrates a portion of map display 402 on a representative mobile device 400 so that user is aware that content is available at a particular location. In the example of FIG. 4, location of cinemas is indicated and a location 404 is noted as having content available. Based on such an indication, a mobile device user is aware that location specific content may be unavailable until the user approaches the location 404. In some examples, content pop-ups icons are displayed as a user approaches a particular location and are removed from a display after a predetermined time or as a user exits the location. While such a display may serve only to inform a mobile device user, the availability of content at a specific location may serve to draw the user to the location, and thus promote goods and services having associated content at the location.

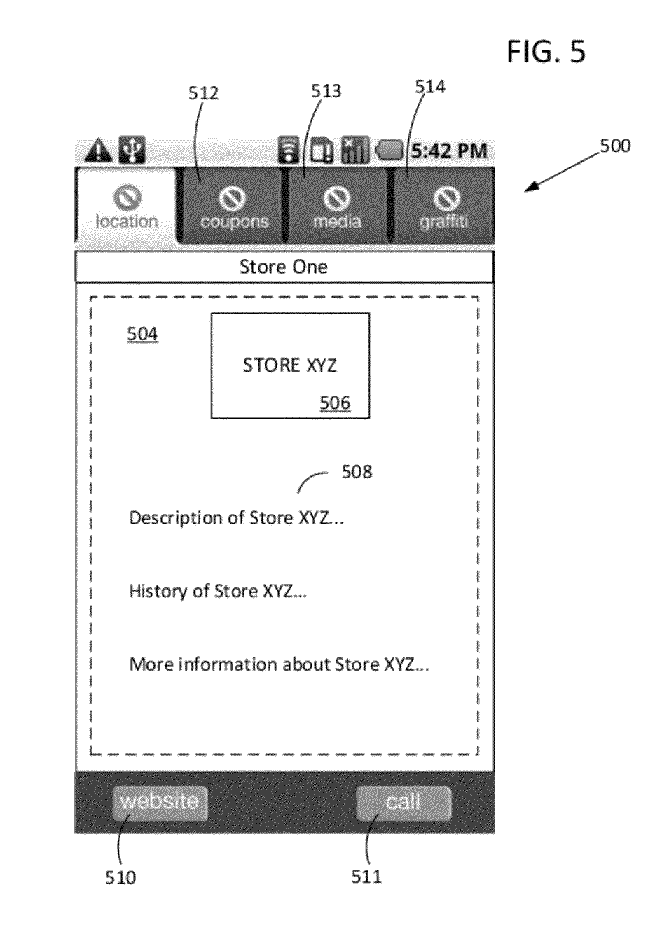

With reference to FIG. 5, a mobile device display 500 is configured to present location information that provides content related to a business located at (or otherwise associated with) a particular location based on an RF signature corresponding to the location. As shown in FIG. 5, a display area 504 is configured to present a business logo or banner 506 and a description of available services or goods 508. For some or all businesses or services for which content is to be provided, additional user input fields 510, 511 can be defined so as to permit users to view a business website or initiate a telephone call, respectively, for device displays that include touchscreen input. Alternatively, fixed user input buttons or switches can be assigned these functions, and the assignment displayed at proximate locations on the display 500. The availability of additional content such as store coupons, media, and user comments is indicated at display areas 512-514 which can also serve as touch screen input areas or dynamically assigned to other hardware inputs. The display areas 512-514 can also be displayed as grayed, colored, or otherwise highlighted to indicate that additional content is or is not available.

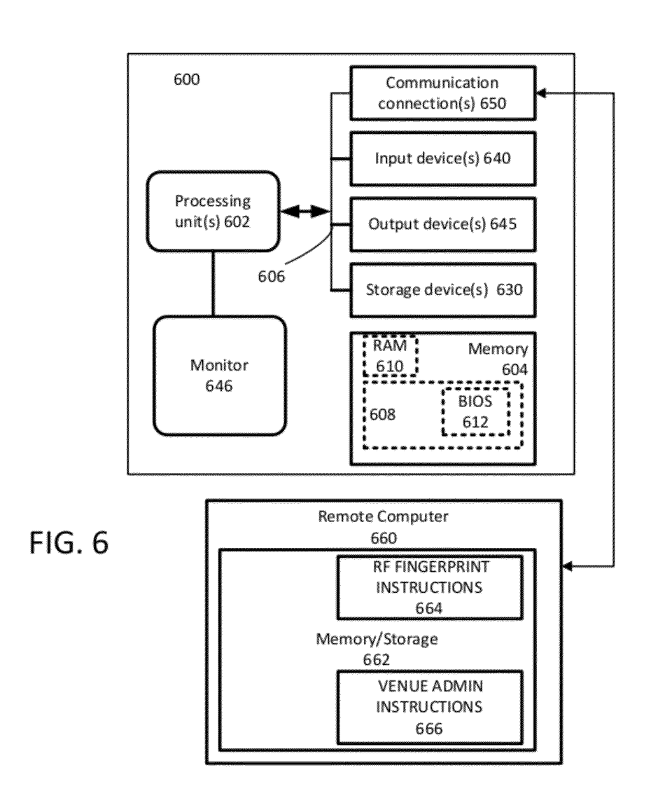

Representative examples are described with reference to particular hardware and software for convenient illustration. In particular, mobile devices that include a touch screen display are used in some examples. However, the disclosed methods and apparatus are not limited to such specific implementation and FIG. 6 and the following discussion are intended to provide a brief, general description of an exemplary computing environment in which the disclosed technology may be implemented. Although not required, the disclosed technology is described in the general context of computer-executable instructions, such as program modules, being executed by a personal computer (PC). Generally, program modules include routines, programs, objects, components, data structures, etc., that perform particular tasks or implement particular abstract data types. Moreover, the disclosed technology may be implemented with other computer system configurations, including hand-held devices, multiprocessor systems, microprocessor-based or programmable consumer electronics, network PCs, minicomputers, mainframe computers, and the like. The disclosed technology may also be practiced in distributed computing environments where tasks are performed by remote processing devices that are linked through a communications network. In a distributed computing environment, program modules may be located in both local and remote memory storage devices.

With reference to FIG. 6, an exemplary system for implementing the disclosed technology includes a general purpose computing device in the form of an exemplary conventional PC 600, including one or more processing units 602, a system memory 604, and a system bus 606 that couples various system components including the system memory 604 to the one or more processing units 602. The system bus 606 may be any of several types of bus structures including a memory bus or memory controller, a peripheral bus, and a local bus using any of a variety of bus architectures. The exemplary system memory 604 includes read only memory (ROM) 608 and random access memory (RAM) 610. A basic input/output system (BIOS) 612, containing the basic routines that help with the transfer of information between elements within the PC 600, is stored in ROM 608.

The exemplary PC 600 further includes one or more storage devices 630 such as a hard disk drive for reading from and writing to a hard disk, a magnetic disk drive for reading from or writing to a removable magnetic disk, and an optical disk drive for reading from or writing to a removable optical disk (such as a CD-ROM or other optical media). Such storage devices can be connected to the system bus 606 by a hard disk drive interface, a magnetic disk drive interface, and an optical drive interface, respectively. The drives and their associated computer-readable media provide nonvolatile storage of computer-readable instructions, data structures, program modules, and other data for the PC 600. Other types of computer-readable media which can store data that is accessible by a PC, such as magnetic cassettes, flash memory cards, digital video disks, CDs, DVDs, RAMs, ROMs, and the like, may also be used in the exemplary operating environment.

A number of program modules may be stored in the storage devices 630 including an operating system, one or more application programs, other program modules, and program data. A user may enter commands and information into the PC 600 through one or more input devices 640 such as a keyboard and a pointing device such as a mouse. Other input devices may include a digital camera, microphone, joystick, game pad, satellite dish, scanner, or the like. These and other input devices are often connected to the one or more processing units 602 through a serial port interface that is coupled to the system bus 606, but may be connected by other interfaces such as a parallel port, game port, or universal serial bus (USB). A monitor 646 or other type of display device is also connected to the system bus 606 via an interface, such as a video adapter. Other peripheral output devices, such as speakers and printers (not shown), may be included.

The PC 600 may operate in a networked environment using logical connections to one or more remote computers, such as a remote computer 660. In some examples, one or more network or communication connections 650 are included. The remote computer 660 may be another PC, a server, a router, a network PC, or a peer device or other common network node, and typically includes many or all of the elements described above relative to the PC 600, although only a memory storage device 662 has been illustrated in FIG. 6. Typically, the memory storage device 662 is configured to store computer-executable instructions for venue administration 666 and/or RF signature determination 664. The personal computer 600 and/or the remote computer 660 can be connected to a logical a local area network (LAN) and a wide area network (WAN). Such networking environments are commonplace in offices, enterprise-wide computer networks, intranets, and the Internet.

When used in a LAN networking environment, the PC 600 is connected to the LAN through a network interface. When used in a WAN networking environment, the PC 600 typically includes a modem or other means for establishing communications over the WAN, such as the Internet. In a networked environment, program modules depicted relative to the personal computer 600, or portions thereof, may be stored in the remote memory storage device or other locations on the LAN or WAN. The network connections shown are exemplary, and other means of establishing a communications link between the computers may be used.

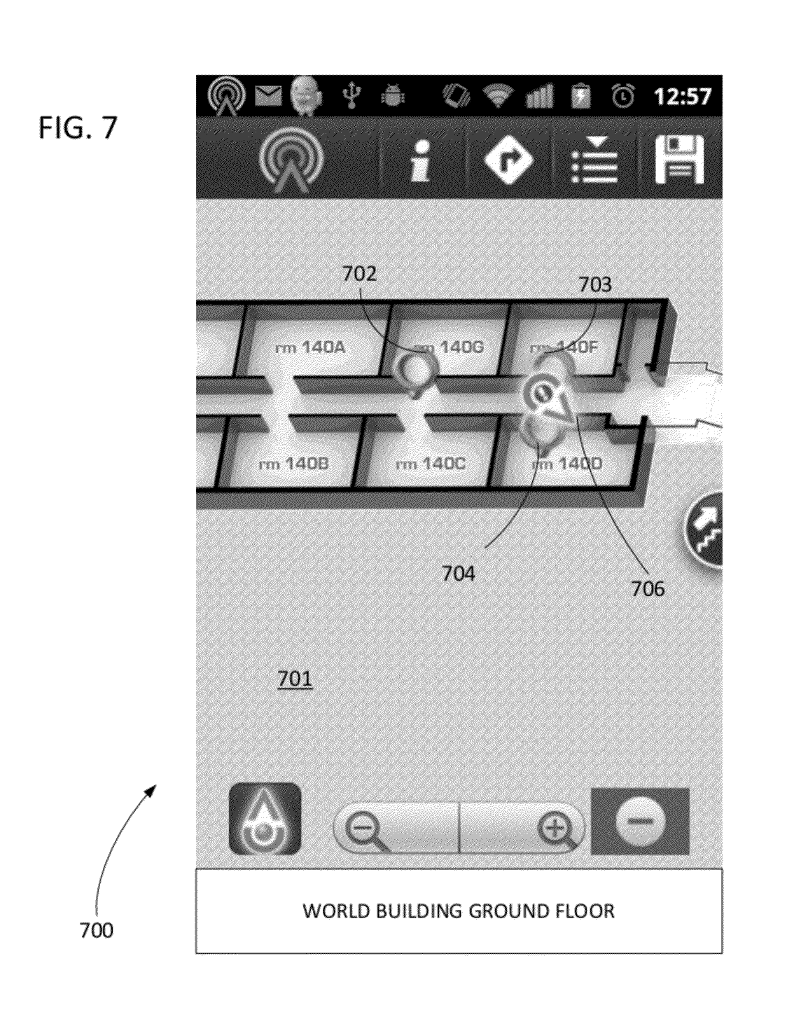

In a particular implementation illustrated in FIG. 7, a mobile device 700 includes a display 701 configured to present a pop-up indicator such as representative indicators 702-704 that indicate the availability of content associated with locations 140G, 140F, 140D and an indicator 706 that provides an estimate of a user location and a direction in which the user is facing, based on the orientation of the mobile device. The mobile device 700 can be configured to transmit RF signatures to a remote location server so that as the user moves about a venue, pop-up indicators such as 702-704 can be presented based on current user location. Pop-up indicators are generally provided as display elements that contain text or graphics concerning goods, services, or other location based information. Pop-ups can be provided as a distinct displayed graphical icon with associated text or graphics. In addition to such visual text or graphics based pop-ups, pop-ups can be provided based on audio or video data, tactile notifications such as a mobile device vibration. Combinations of such notifications can also be provided, for example, a mobile device vibration can be associated with initiation of an audio containing location specific information or can serve as a notification that content text or graphics are available on a mobile device display. Alternatively, the mobile station can be provided with a local database of RF signature data so that a mobile device processor can update mobile device location. The mobile device 700 can then transmit the mobile device location to a location based content database and receive pop-up indicator map locations. Alternatively, all of or a portion of venue content (including pop-up indicators) can be stored in computer readable media at the mobile device 700, or some data can be locally stored, and some data remotely stored.

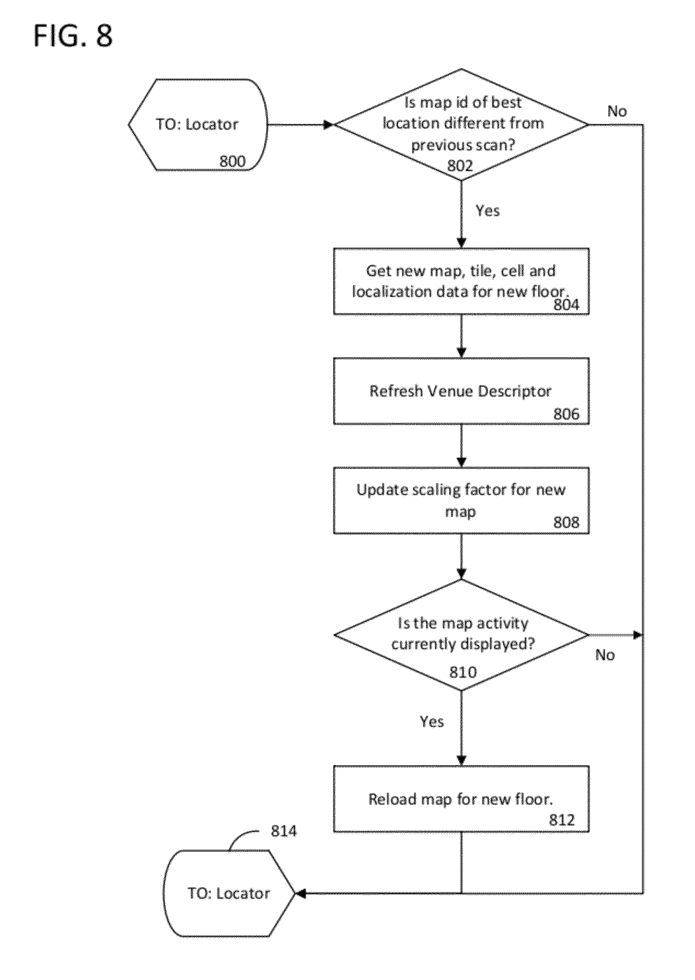

FIG. 8 illustrates a method of detecting a change in a location of a user device. In some examples, a change in floors in a multi-floor venue is detected, and a mobile device display is updated with a corresponding floor map and associated content. A location request is generated at 800, and current location identifier is returned. At 802, a map associated with the current location is identified, typically with reference to a map identifier such as a map name, alphanumeric string, or identification bytes. The map identification of the current location is compared with a map identifier from previous scan of available access points and RSS values. If the current map identifier is different, a new map, tile, cell, and other location data associated with the current location are obtained at 804. In some examples, the current location may correspond to a change of floors in a multi-floor venue.

At 806, a venue descriptor is updated based on the new map, so that appropriate venue information for the current location is available on the map. At 808, a map scaling factor is adjusted so that the new map can be displayed and navigating distance can be determined. At 810, a status map activity display is evaluated. If map activity is not displayed, a request for location is made at 814. In map activity is currently displayed, then the map for the new location (such as a new floor) is loaded at 812, and then the request for location is made at 814.

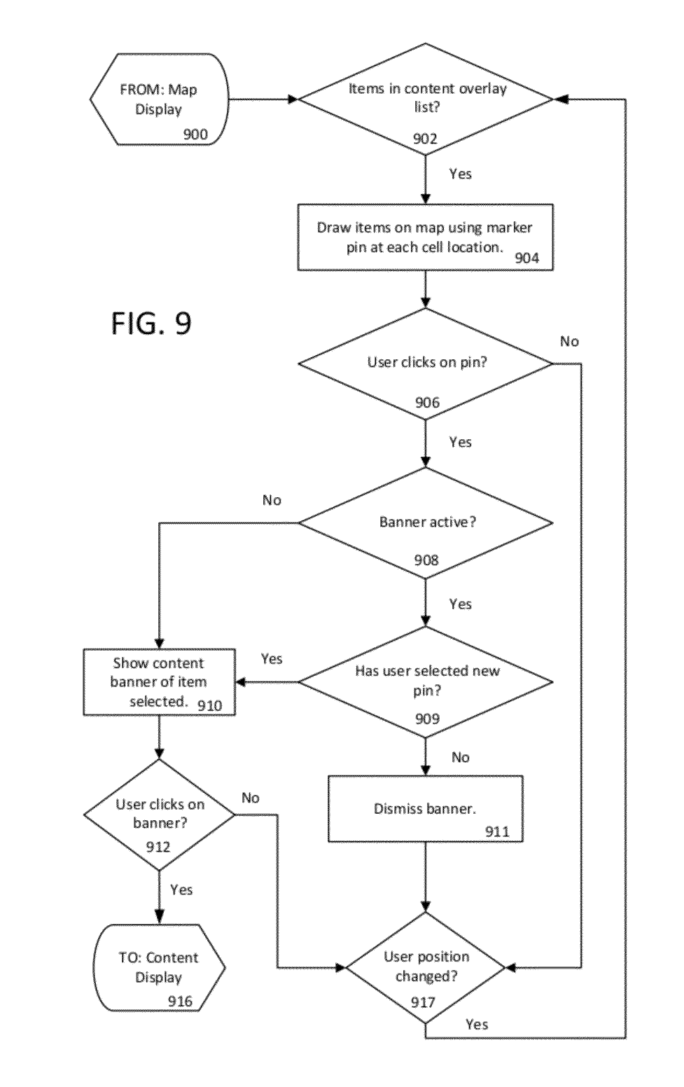

With reference to FIG. 9, display of content with respect to a map includes obtaining and displaying a map for a current location at 900. At 902, content associated with or overlaid on the map is identified, or the lack of such content is verified. If there is overlay content, at 904, locations with which content is associated are indicated by displaying a pin or other visual indicator at the locations. The visual indicators can be different for various types of associated content or characteristics of nearby vendors in the venue.

At 906, user selection of one or more pins (typically as a touch to a location on a touchscreen at which the pins are displayed) is detected, and at 908 a status of a banner is evaluated. If a banner not active, at 910, banner content associated with the selected pin is displayed. If the user selects the banner at 912, content display for the selected pin is activated at 916. The banner is active at 910, at 909 the pin is compared with a previously selected pin to check if a new (different) pin has been selected. If the pin is newly selected, the content banner is displayed at 910. If a new pin is not selected, the banner is dismissed at 911. Finally, at 917 user position is monitored for changes. Upon detecting a user position change, the method returns to 902 to assess the availability of content.

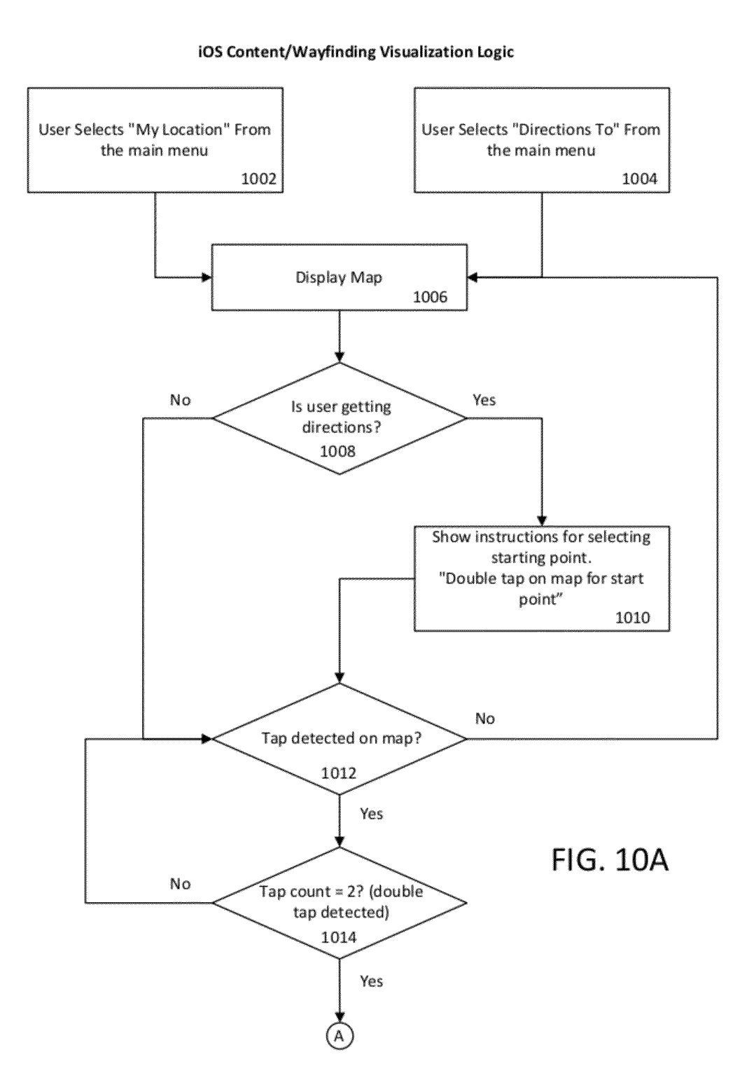

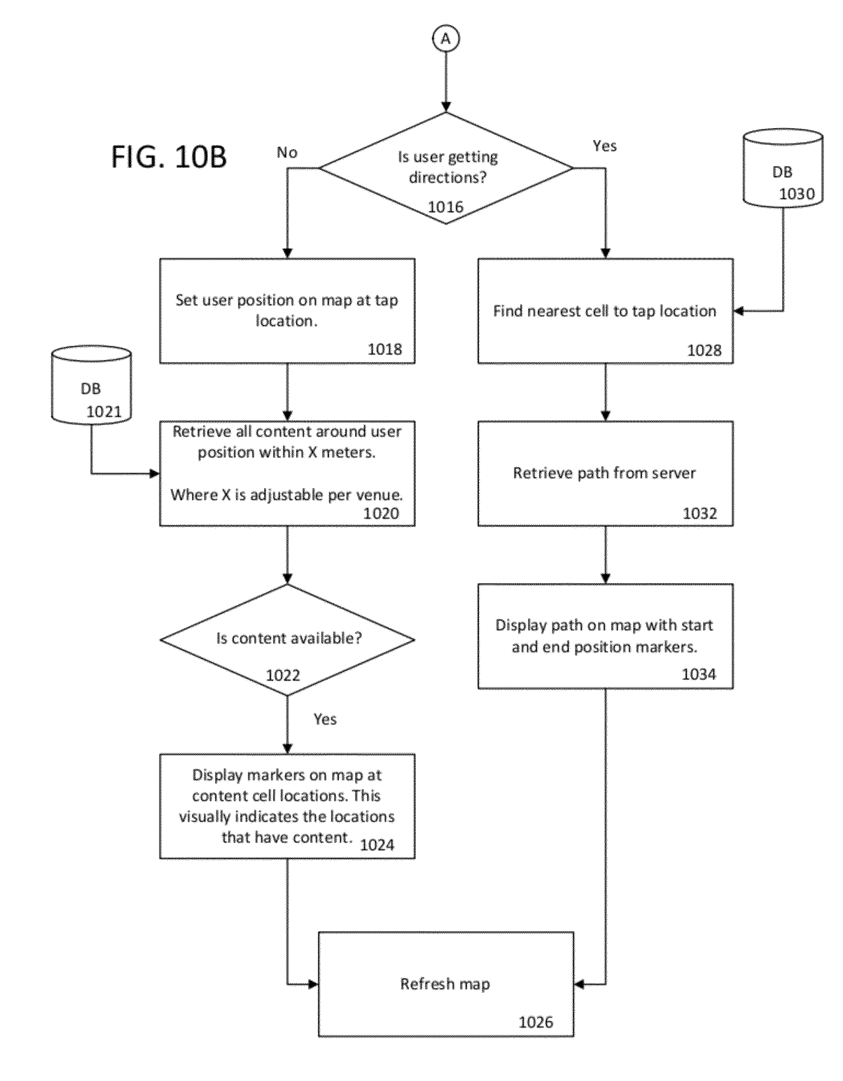

FIGS. 10A-10B illustrate a method of providing content and way finding information. At 1002, a user requests determining and displaying user location, and at 1006, a map is displayed along with a visual indicator of user position. Alternatively, at 1004, a user can request directions, and a map displayed at 1008. If the user has requested directions, at 1008 the method proceeds to 1010 for the display of instruction for selecting a route starting point. For example, a request such as “double tap map for start point” can be displayed to assist the user in establishing a route. It a tap is detected at 1012, a tap count is evaluated at 1014 to identify a double tap. If the user is getting directions, at 1016, processing is directed to 1028 at which a nearest map cell the tap location is obtained, typically based on a map database 1030. A path between the tapped location and the requested location at 1004 is obtained at 1032, and the path is displayed at 1034. If a user position is requested, at 1018 the user position is set on the displayed map at the tap location. At 1020, content around the user position within a predetermined or venue selectable distance such as 1, 2, 5, 10, 15, 20, or 50 m is retrieved from a database 1021. The availability of content is assessed at 1022, and at 1024, markers are displayed at locations for or at which content is available. Then, at 1026, the map can be refreshed.

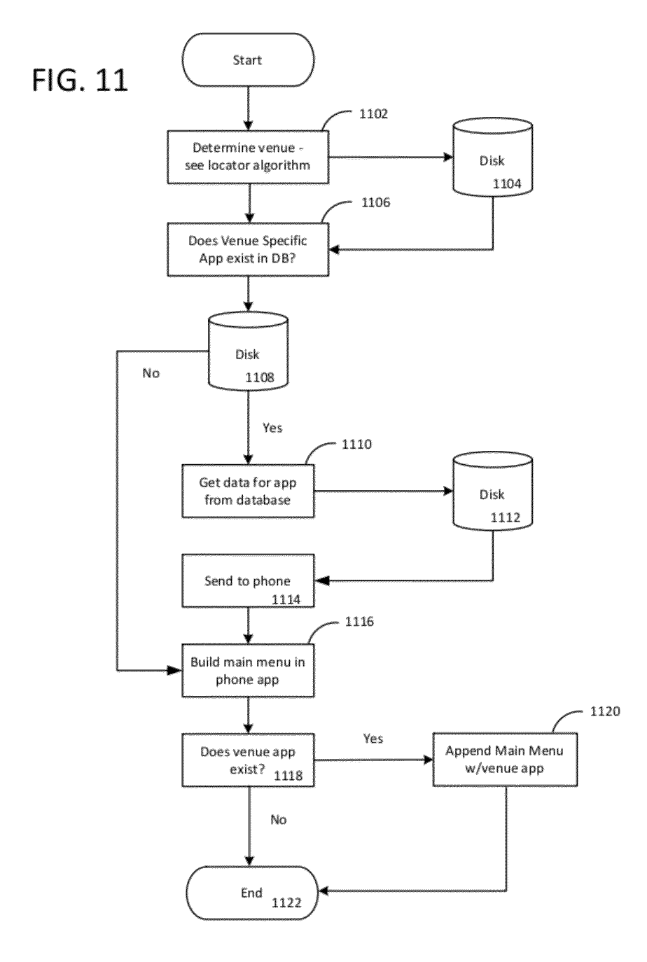

Typically, modules, components, or applications for content retrieval can be delivered to user devices based on the availability of venue specific applications, or venue specific content. With reference to FIG. 11, a method of delivering a venue specific application includes determining a venue at 1102 by querying a venue database stored on a disk or in other computer readable media 1104. An application database stored at 1108 is they queried to determine if a venue specific application is available at 1106. If a venue specific application is available, at 1110 data for the application is retrieved from a database 1112, and the application and the application data are forwarded to a mobile device at 1114. At the mobile device, a main menu for a content delivery application is built at 1116, and if a venue application currently is available to the mobile device, the venue specific application modifies the main menu at 1120. If a venue application is not available at 1118, no further modification of the content delivery application, and application delivery ends at 1122.

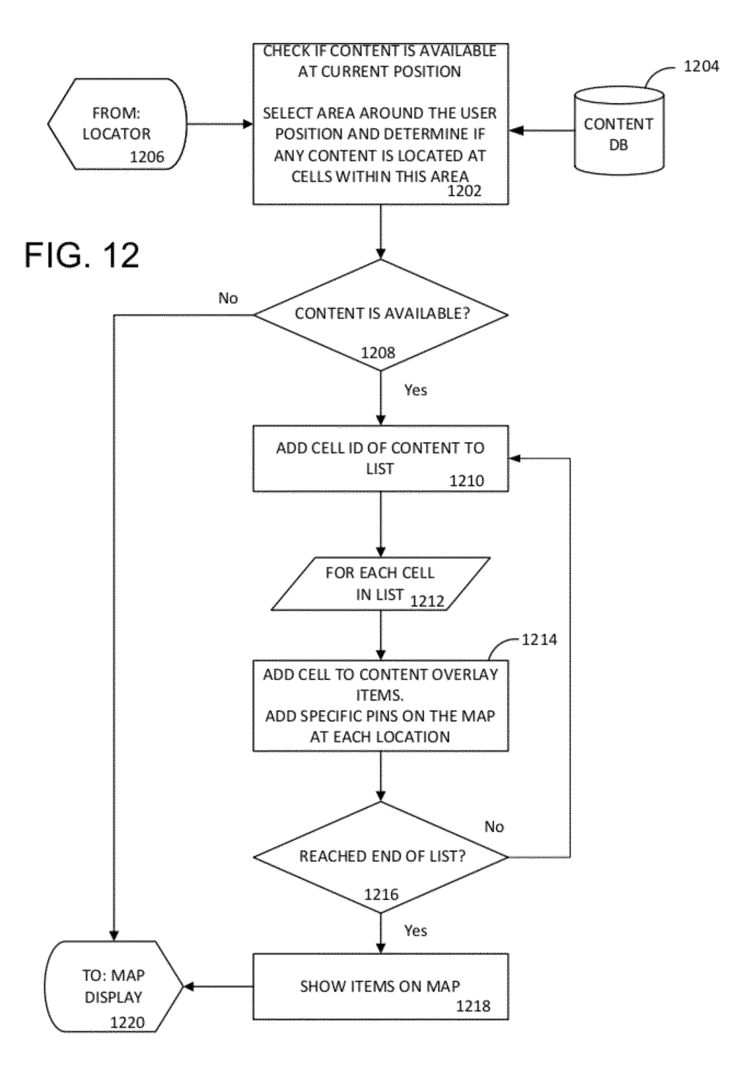

With reference to FIG. 12, content from a remote database can be provisioned to a mobile device or other device as follows. At 1206, a current location is determined, and at 1202 a query is made as to the availability of content associated with an area around a user location in conjunction based on a content database 1204. If content is available at 1208, a cell identifier or other location identifier associated with available content is added to a list of content locations at 1210. At 1212, for some or all cells in the list, the cell is added to a list of cells for which content can be overlaid on a display. If the end of the list of cells is reached at 1216, available items or the availability of items (such as, for example, content pop-ups) are shown on the displayed map at 1218, and display of the updated map continues at 1220. If no content is available, map display similarly continues at 1220.

With reference to FIG. 13, a venue specific content delivery system generally includes a venue management server 1302 that can be configured to assess venue traffic analysis, conduct user profile analysis, and to manage content based on computer-executable instructions stored in a non-transitory medium 1304. In addition, a locator engine 1306 (typically implemented computer-executable instructions and a database of RF fingerprints) is configured to estimate user device location based on received RF access point data such as BSSIDs and RSSs. Components are implemented in hardware or software for navigation 1302 based on navigation database 1314 that can include general purpose navigation data at 1312 as well as customized data for individuals or groups of individual based on one or more disabilities. A location based service module 1308 is configured to provide location based content, venue specific applications, and bookmarked offline content.

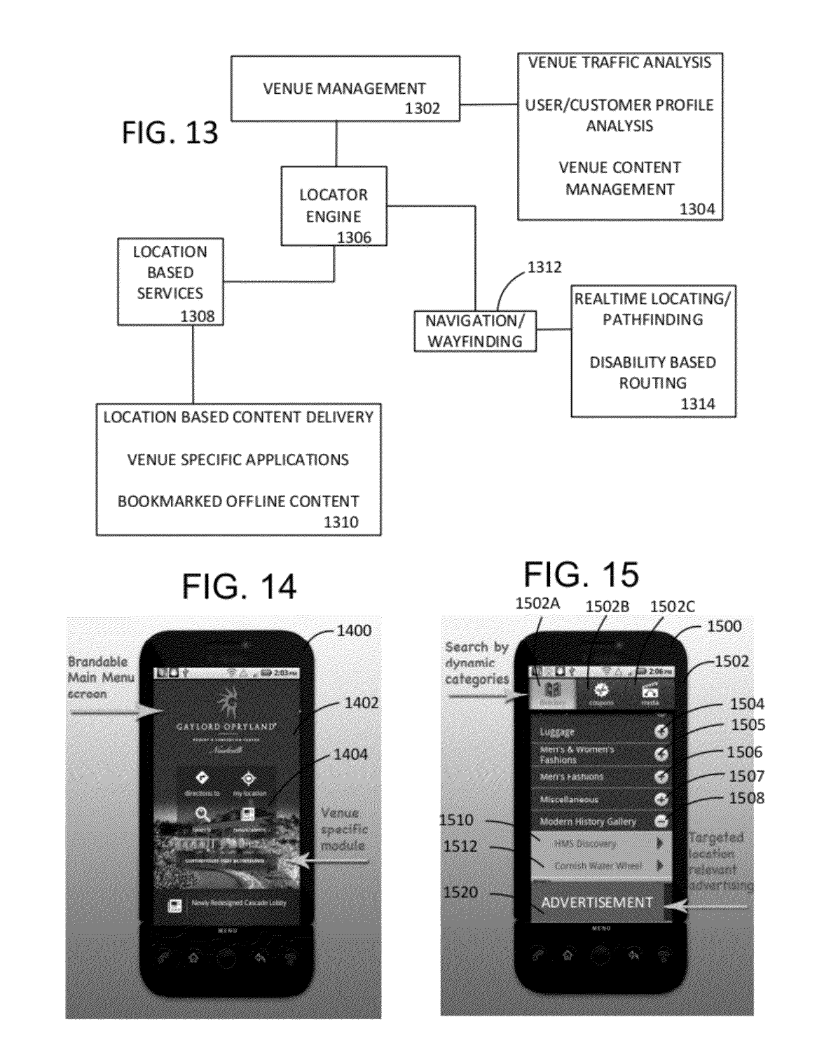

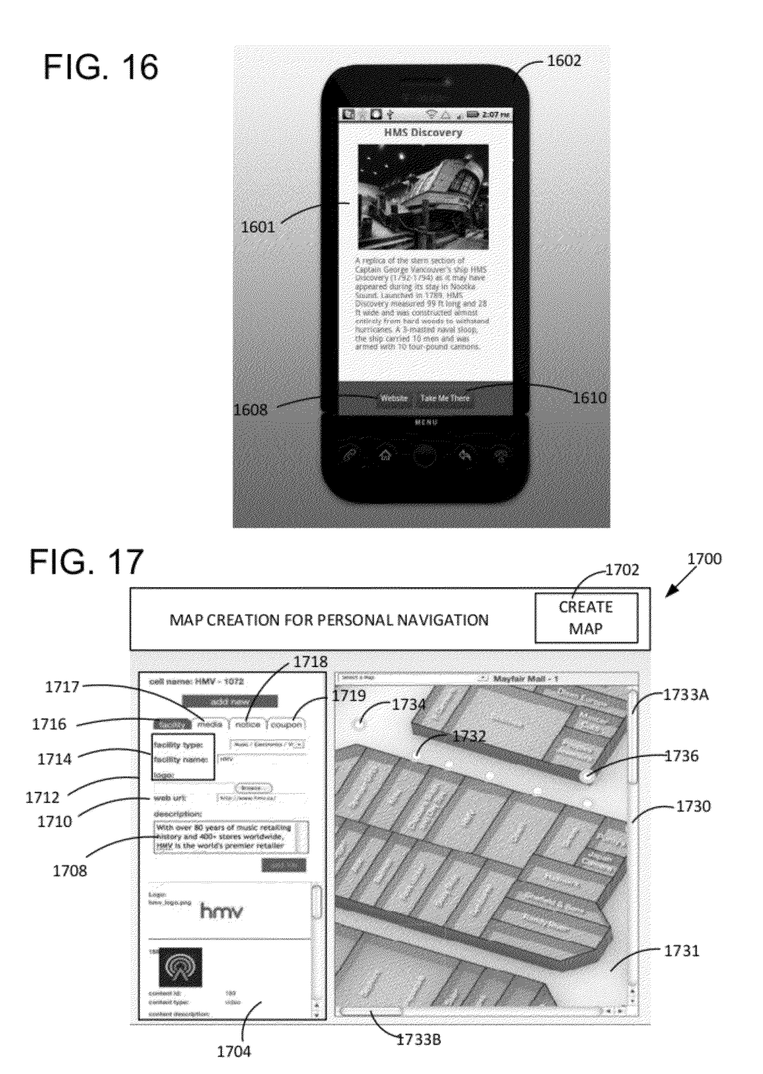

FIG. 14 illustrates a mobile device 1400 having a display that includes a main menu screen area 1402 that can be used to display an image that may be a venue name or logo, and a user command area 1404 associated with entry of user commands into a content delivery application along with a user command are for user activation of a venue specific module. FIG. 15 illustrates a mobile device display 1500 that includes touch screen display and input areas 1502A-1502C associated with accessing and/or searching a venue directory, available coupons, and available media, respectively, that are associated with one or more locations. In addition, combined input and display regions 1504-1508 are configured to display types or categories of available goods and services at a selected venue, and input/display regions 1510, 1512 are configured to permit selection of detailed content as a subset of the types or categories in 1504-1508. A banner advertisement or other banner content is display at 1520. FIG. 16 illustrates a mobile device 1602 that is configured to display information about an item of interest at maritime museum. User inputs 1608, 1610 are provided for accessing a museum web site or telephoning the museum, and display area 1601 is provided for information concerning the item.

FIG. 17 illustrates a user interface 1700 for creation of navigation maps and the assignment of location-based content. In some examples, such as user interface is associated with content assignment at a venue content server by venue administrator, or such an interface can be presented to a remote venue administrator via a local or wide area network such as the Internet. A create map user input area 1702 can be activated to assign content or revise assigned content. A data input area 1712 is provided for assignment of various types of content, include text, audio, video, images or other data and a map area 1730 is provided and configured to display locations to which content has been assigned and to permit a venue administrator to select and assign content to additional locations. As shown in FIG. 17, representative locations 1732, 1734, 1736 are selected for content assignment on a venue map 1731. Additional portions of the map 1731 can be made available to the venue administrator using scroll bars 1733A, 1733B.

The data input area 1712 includes an “add new” input area to permit generation of a new location or cell to which content can be assigned. A user can select a location associated with such a new cell by tapping the map 1731 (if displayed on a touch screen) or using a pointing device such as a computer mouse or trackball, or using arrow keys on a keyboard. An existing cell can similarly be user selected for addition or revision to assigned content. The example user input area 1712 includes tabs 1717-1719 associated with facility descriptions, associated media, notices, and coupons, respectively. Generally such content is related to vendors situated at or near the cell location, but content for remote or competing locations can also be included to, for example, entice a potential customer to continue to another store. A facility description area 1714 is provided for inclusion of names, logos, types of goods or services or other textual or graphic information and a display area 1708 is provided for display and entry of facility descriptions and a URL display area 1710 is provide for display and entry of vendor Internet address. A display area 1704 is provided for content files and configured to provide visual previews as well as content info, information such as type and size of content file.

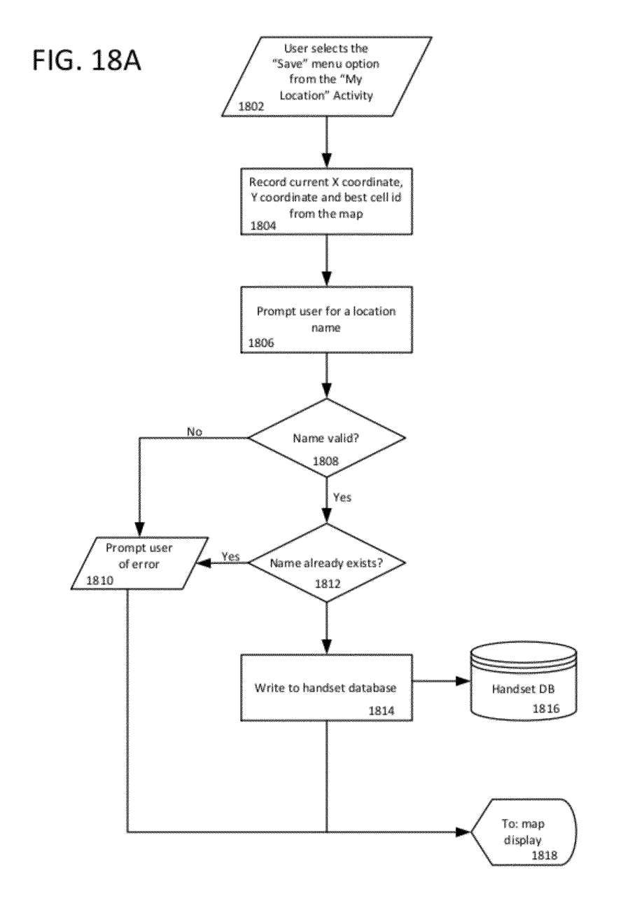

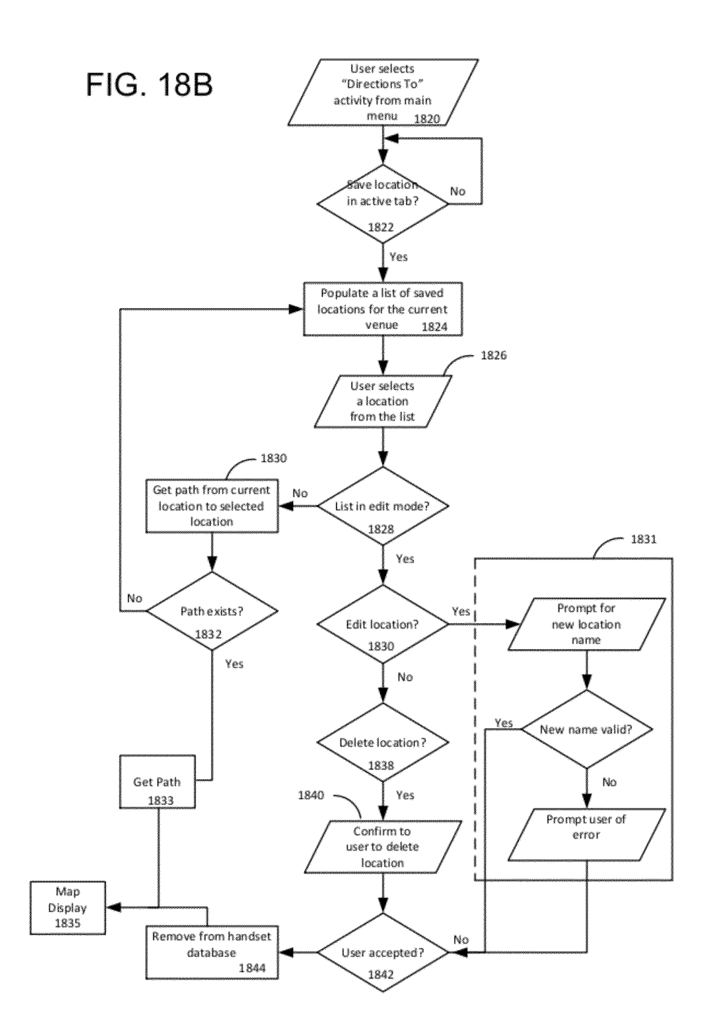

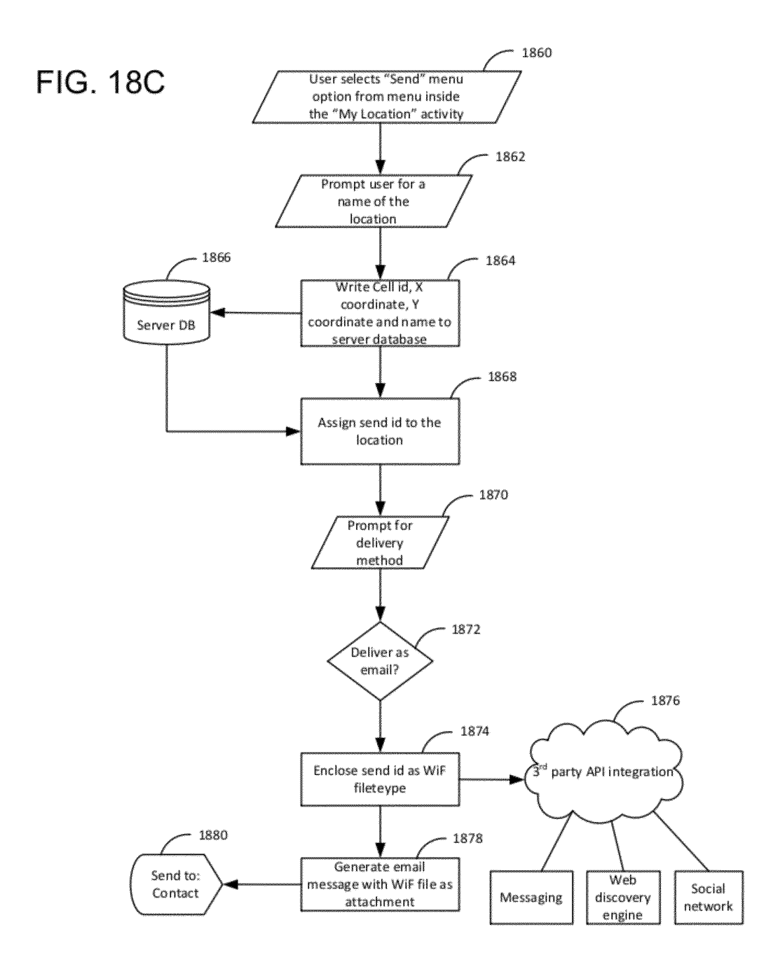

With reference to FIG. 18A, a representative method of saving a user's location which may represent a meeting place or a location of a user's car at a mobile device such as a handset includes selecting to save location at 1802 and recording current coordinates associated with the RF signature of a cell associated with a current location of the mobile device at 1804. Typically, a prompt for a location name is provided at 1806, and a requested name is checked for validity with respect to, for example, permitted characters and length at 1808. If an invalid name is requested, at 1810 a message is displayed that can merely note the error or provide information concerning the error. If the name is already in use as determined at 1812, an error message is displayed at 1810. If a valid name is requested, the name is stored in a database 1816 at the mobile device at 1814. A named location can be displayed on map presented on the mobile device at 1818. A user can elect to save a variety of locations such as parking places, meeting places, stores, artwork, meeting rooms for applications in shopping malls, museums, convention centers, universities, or other public or private spaces.

At 1820, a user can select to obtain directions to one or more saved locations. For example, a user can request a route back to a parking place whose location was previously saved. (In addition, saved locations can be shared as shown in FIG. 18C below and, for example, a route to a different system user's car can be chosen.) If a user saved location is still active, the location is stored at 1822. At 1824, a list of saved locations for the current venue is populated and the user selects a location at 1826. The list can be presented in for editing at 1828 and if editing of the list is not requested, a path from the user's current location to a selected location is selected at 1830 obtained at 183. The path is then presented on the map of the venue in the mobile device at 1835. If locations are to be edited at 1830, a new location name can be provided at 1831. A request for location deletion from the list at 1838 is generally followed by a confirmation request at 1840. Once renaming or deletion of a location or name is accepted at 1842, the location or a previous name can be removed from the location database at the mobile device at 1844.

In many situations, users are permitted to provide preferred locations to friends, family, work colleagues, or others. For example, as shown in FIG. 18C, a user selects a send menu at 1860 and is prompted to enter a location name at 1862. At 1864, a cell or location identifier, cell coordinates, and a location name are stored in a database 1866. This stored location information is can be assigned a send identification at 1868 and a method of delivery selected at 1870. For example, email delivery can be requested at 1872. The send identification is prepared for delivery at 1874, and delivered via an external application 1876 such as a third party sharing application such as a social media application or text or messaging application. In some examples, the location is sent be generating an email with attached or included location information at 1878, the email is forwarded to a contact at 1880. Typical examples include users sending meeting locations to contacts, or aid a contact to find a specific location (and associated content) as preferred by the location sender. The recipient of such location information can generally obtain a path from their present location (or other location) to the shared location in a manner similar to that illustrated in FIG. 18B, typically by selecting a location from a list.

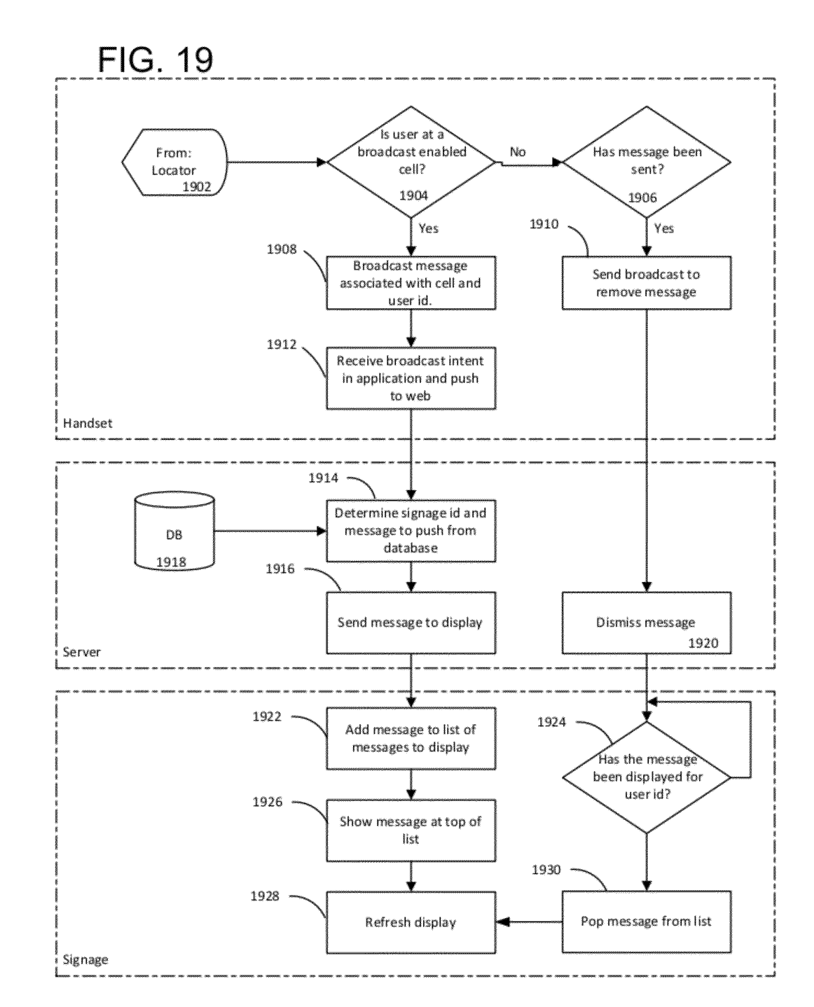

With reference to FIG. 19, a representative method of interacting with digital signage with communications between a handset, a server, and a digital sign includes determining if a mobile device user is at a broadcast enabled cell at 1904 based on a user location established at 1902. If broadcast is enabled at the current cell, a message associated with the cell and the user identification is broadcast at 1908 and pushed to a server at 1912. At the server, a signage identifier is extracted from a database 1914, and the message is forwarded for display at 1916. The message is added to a list of messages at the digital signage at 1922, and the message is added at a preferred location (such as a top or bottom) of a list of messages at 1926. At 1928, the signage display is refreshed. If the user message has been sent but at a non-broadcast enabled cell, message removal is requested at 1910. At server, the message is dismissed at 1920. At the signage, if the message has been displayed as determined at 1924, the message if popped from the list at 1930 and the display is refreshed at 1928. In this way, messages on digital signs can be provided based on user presence at the signage and customized to a particular user profile. After the user departs the cell or location of the signage, the customized message can be removed and replaced with another custom or general message.

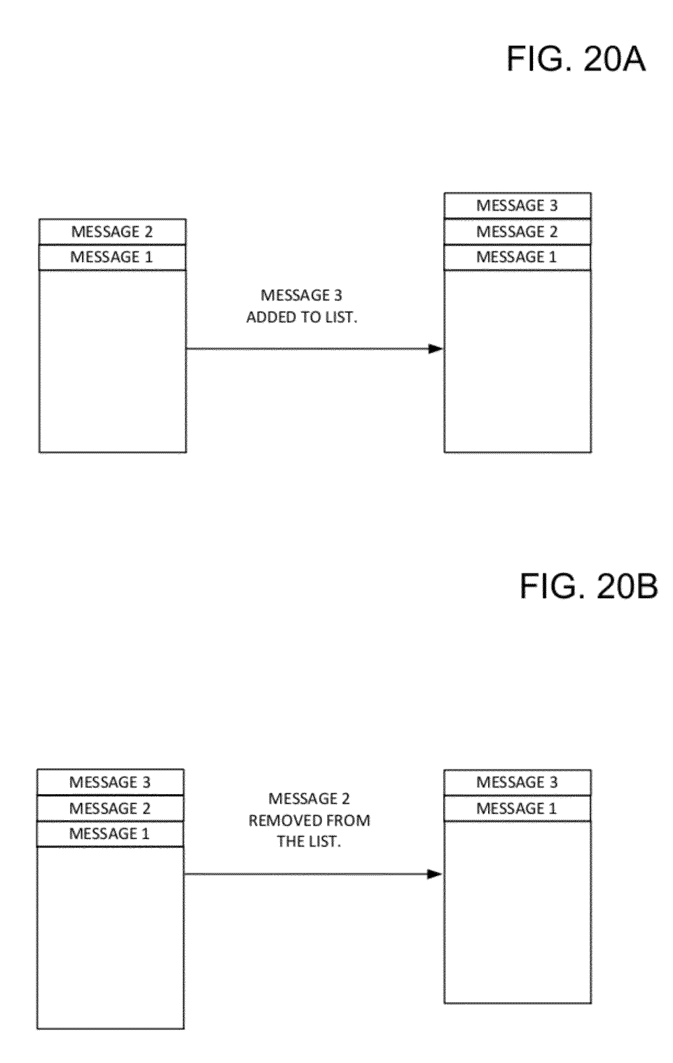

FIGS. 20A-20B illustrate message updates associated with interactions with digital signage. FIG. 20A shows addition of a new message (MESSAGE 3) to a top of a list of messages displayed on a handset. FIG. 20B shows removal of a message (MESSAGE 2) from a list in response to, for example, the user no longer being present at a location associated with the message.

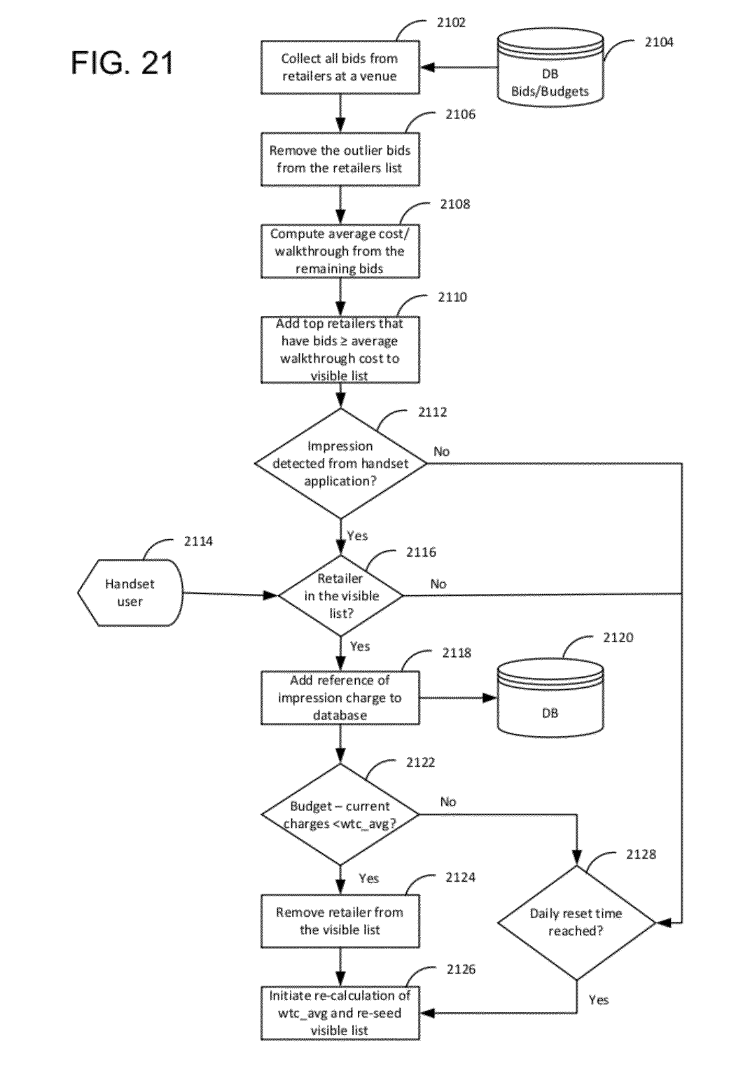

With reference to FIG. 21, a method of making venue content available from selected vendors includes collecting bids from vendors at 2102 and/or retrieving bids from a database 2104. Bidder budgets can be stored as well, typically as a budget for a repeating time period such as amounts per day, week, month or other time period. Outlier bids such as those from bidders having no available budget for a selecting time period such as an hour, day, week, or month or that are substantially different from the bid mean can be removed from at 2106. An average cost per walkthrough (wtc_avg) based on user collected bid minus outlier bids can be estimated, and retailers whose bids are greater than an average walkthrough cost are added to a retailer list at 2110. The retailer list can also be limited to bidders whose bids are larger or smaller.

If an impression related to a retailer on this retailer list is received at 2116 based on what content is viewed by a user and where the content is viewed, or based on scanning a bar code of a selected retailer product, a reference to this impression is added to a database 2120 to assess charges at 2118. Impressions include viewing of retailer content, purchases associated with the content such as use of a coupon, or entry to vendor premises at substantially the same time the vendor content is presented, or within a predetermined time period later. Typically any viewing or access to content provided by a bidding process can be used as a basis for charging a bidder. In many cases, a bid process is arranged to provide vendor coupons, and use of coupons can be associated with bidder charges. At 2122, total charges to a bidder are compared with the bidder budget, and if the budget has been exceeded, the retailer is removed from the list at 2124. Average walkthrough cost is recalculated and the retailer list is revised at 2126. If the bidder has exceeded his budget for a time period such as a day or week, at 2128 it is determined if the budget should be reset for a new time period.

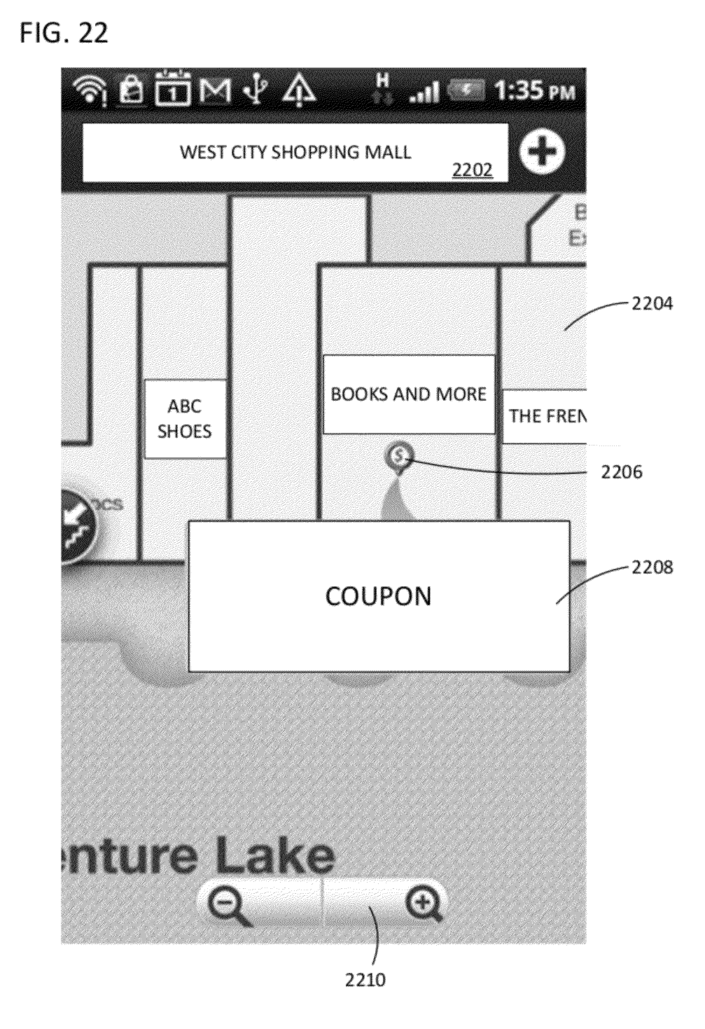

FIG. 22 is a representative example of a mobile device display configured to present a venue title 2202 and a venue map 2204 identifying content locations such as representative content location 2206. The content location 2206 is displayed so as to include a currency symbol or other symbol to indicate the availability of a discount coupon for a nearby vendor. A representation 2208 of the discount coupon can be displayed, and the display of the venue map 2204 and coupon 2208 can be enlarged or reduced using the toolbar 2210.

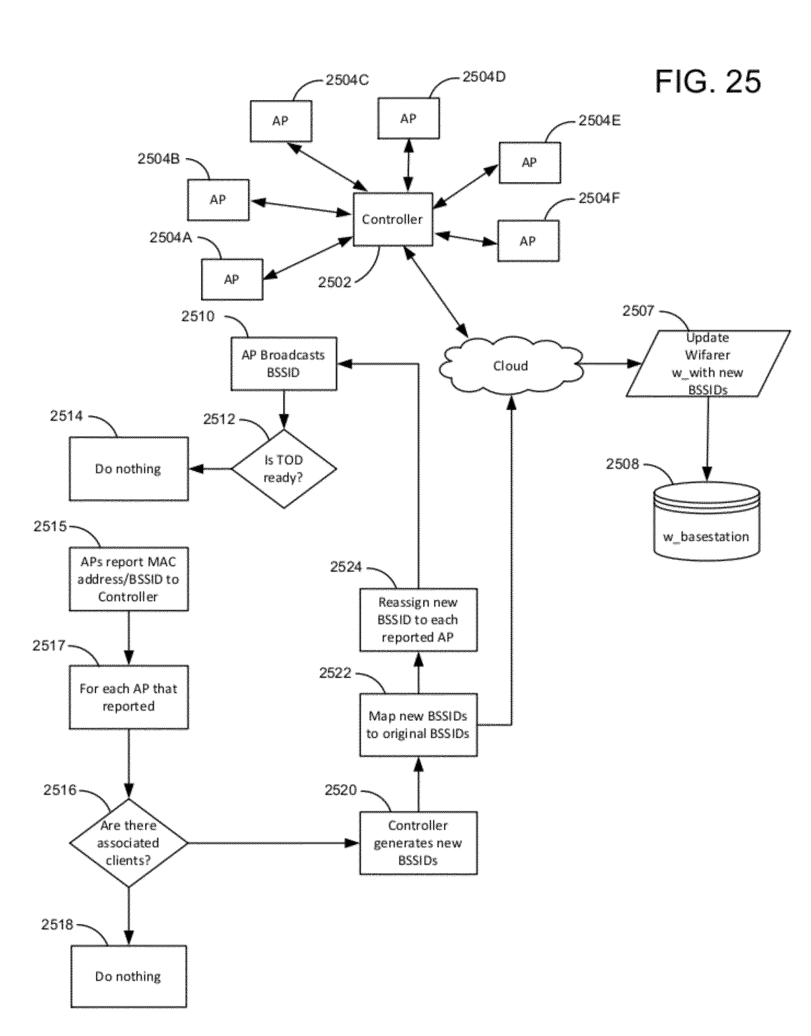

In some cases, development of a content database requires considerable effort, and venue administrators may prefer to restrict access to the database. Instead of limiting access based on a password or the like, access point names can be periodically re-assigned so that location specific content for one location appears to be assigned to a different location. Content requests made to the venue administrator from authorized locations, devices, or users can retrieve appropriate content, while other content requests receive inappropriate content. Referring to FIG. 25, at 2502 a controller develops and assigns BSSIDs for a plurality of access points 2504A-2504F and communicates the BSSIDs via a wide area network 2506. At 2507, the BSSIDs are updated in a database 2508. In operation, the access points broadcast identifier such as BSSIDs at 2510, and at 2512, it is determined if the time of day (TOD) is appropriate for BSSID re-assignment (which is preferably done at times associated with minimal system usage). If the TOD is inappropriate, no further action in this regard in taken at 2514. Otherwise, at 2513, the access points report MAC addresses and/or BBSIDs to the controller, and for each reporting access point, it is determined if any clients are currently associated with the access points at 2516. If one or more access points has clients, re-assignment is postponed or cancelled at 2518. Otherwise, new BSSIDs are generated at 2520 and mapped to the current or original BSSIDs at 2522. The BSSID of each reporting access point can then be re-assigned at 2524. In other examples, one or a few access points are subject to BSSID re-assignment, and re-assignment of all is only one example. With such re-assignment, even if a prior user has established an RF signature for an access point with local content, BSSID re-assignment is effective to at least temporarily interfere with content access unless access to the re-assignment is available. In this way, venue administrators can control access to content.

It will be recognized that the illustrated embodiments can be modified in arrangement and detail without departing from the principles of the disclosure. For instance, elements of the illustrated embodiments shown in software may be implemented in hardware and vice-versa. Also, the technologies from any example can be combined with the technologies described in any one or more of the other examples. In view of the many possible embodiments to which the principles of the disclosure may be applied, it should be recognized that the illustrated embodiments are examples and should not be taken as a limitation on the scope of the disclosure. For instance, various components of systems and tools described herein may be combined in function and use.

We claim:

1. A content delivery system, comprising:
a network interface configured to receive requests for content associated with a selected map location, the request including a radio frequency (RF) signature associated with the location; and
a processor configured to identify at least one content element associated with the RF signature.

2. The content delivery system of claim 1, wherein the RF signature is associated with a wireless access point identifier and at least one received signal strength associated with the wireless access point.

3. The content delivery system of claim 1, wherein the processor is configured to retrieve the at least one content element and communicate the content element via the network interface.

4. The content delivery system of claim 1, wherein the content element is an audio file, a video file, or a text file.

5. The content delivery system of claim 1, wherein the processor is configured to provide an indication of the availability of content associated with map locations proximate the selected map location.

6. A system, comprising:
at least one computer readable media configured to store RF signatures in association with corresponding map locations and content;
a user interface configured to receive selections of map locations and assign content to at least one of the map locations.

7. The system of claim 6, further comprising assigning at least one content notice type to a content item, wherein the content notice type is associated with display of the content item based on presence at the associated location.

8. The system of claim 6, further comprising a map display configured to display a map location for the assignment of content.

9. The system of claim 8, wherein the content is an audio file, a video file, a text file, or an image file.

10. The system of claim 8, wherein the content item is a coupon associated with a vendor having a location at the selected map location.

11. The system of claim 8, wherein the content is assigned based on a value indicator.

12. A method, comprising:
providing vendor specific content associated with a location based on a radio frequency signature;
receiving at least one indication of user access to the vendor specific content; and
estimating a value of the user access associated with the at least one indication.

13. The method of claim 12, wherein the estimating the value is based on a number of user accesses to the content.

14. The method of claim 13, wherein further comprising determine a number or user accesses to vendor premises associated with content.

15. The method of claim 13, wherein the vendor specific content is a vendor coupon.

16. A method, comprising:
obtaining radio frequency (RF) signatures for a plurality of venue locations;
assigning content to at least one venue location; and
providing content in response to receipt of an RF signature associated with at least one vendor location.

17. The method of claim 16, wherein the content comprises at least one of audio, video, images, or text.

18. The method of claim 17, wherein the RF signatures include a location identifier and at least one characteristic of the radio frequency emissions associated with the location.

19. The method of claim 18, wherein the location identifier includes a Service Set Identifier associated with a wireless access point proximate the location.

20. The method of claim 18, wherein at least one content item is denoted as a pop-up item.

21. A mobile device, comprising:
a radiofrequency receiver configure to detect radio frequency transmissions from wireless access points;
a processor configured to determine the mobile device location based on the detected transmissions; and
a display configured to provide an indication of available location based content on a map of a venue.

22. The mobile device of claim 21, wherein the processor is configured to determine the mobile device location by communicating characteristics of the detected transmissions to a remote venue database.

23. The mobile device of claim 21, wherein the processor is configured to determine the mobile device location based on a venue database at the mobile device.

24. A content management system comprising:
a database configured to store current BSSIDs and associated content; and
a controller configured to update at least one BSSID and store the updated BSSID in the database.
